(19) United States
(12) Patent Application Publication
(10) Pub. No.: US 2026/0335807 A1
(43) Pub. Date: Oct. 29, 2026

(54) PURIFICATION APPARATUS FOR SOLID WASTE INCINERATION FLUE GASES

(71) Applicant: Hainan Nuclear Power Co., Ltd., Changjiang County (CN)

(72) Inventors: Pan Ding, Changjiang County (CN); Wei Wang, Changjiang County (CN); Chi Zuo, Changjiang County (CN); Yong Xiao, Changjiang County (CN); Xingxu He, Changjiang County (CN); Yongsheng Zhao, Changjiang County (CN)

(21) Appl. No.: 19/428,388

(22) Filed: Dec. 22, 2025

(30) Foreign Application Priority Data
Apr. 29, 2025 (CN) 202510554236.8

(51) Int. Cl. B01D 53/04; B01D 46/02

(52) U.S. Cl. CPC B01D 53/0438; B01D 46/02; B01D 53/0446; B01D 2253/108; B01D 2257/2045; B01D 2257/2047; B01D 2257/302; B01D 2257/40; B01D 2258/0291

(57) ABSTRACT

Provided is purification apparatus for solid waste incineration flue gases, comprising a heat exchanger, a quenching tower, a dust collector, a cooler, a gas-liquid separator and an adsorption device communicating in sequence through pipelines. High-temperature solid waste incineration flue gases undergo cooling by the heat exchanger, rapid quenching by the quenching tower, dust removal by filtration by the dust collector, cooling by the cooler and gas-liquid separation by the gas-liquid separator, so as to yield low-temperature solid waste incineration flue gases and flue-gas cooling water; and the low-temperature solid waste incineration flue gases enter the adsorption device to undergo adsorption purification before discharge.

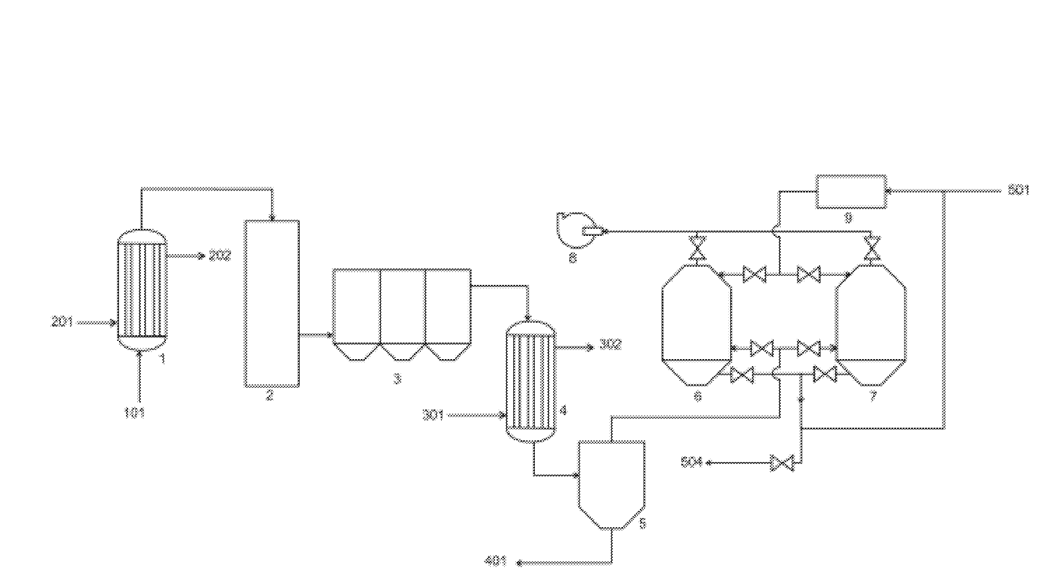

### CROSS-REFERENCE TO RELATED APPLICATION

The present disclosure claims the priority to the Chinese patent application with the filing No. 2025105542368 filed with the Chinese Patent Office on Apr. 29, 2025, the contents of which are incorporated herein by reference in entirety.

### TECHNICAL FIELD

The present disclosure relates to the technical field of purification of solid waste incineration flue gases, and particularly to a purification apparatus for solid waste incineration flue gases.

### BACKGROUND ART

Incineration of solid wastes will produce a large amount of solid waste incineration flue gases. In order to avoid secondary pollution to the environment, the solid waste incineration flue gases need to undergo strict purification treatments so as to sufficiently remove pollutants therein prior to discharge. The pollutants in the solid waste incineration flue gases mainly include acid gases such as flue gas, sulfur dioxide, oxynitride, and hydrogen chloride, along with carbon monoxide, dioxin, heavy metals, among others. Treatment and control of pollutants in solid waste incineration flue gases are of vital significance to human health and environmental protection. These flue gases often carry substantial residual heat, and direct discharge would not only cause significant energy consumption, but also impose severe pollution to surrounding environment. Therefore, the solid waste incineration flue gases require purification treatment prior to discharge.

Conventional flue gas purification treatment systems typically have functions of cooling, dust removal, deacidification, denitration and the like on solid waste incineration flue gases. Conventional flue gas purification treatment processes mainly include SNCR denitration, deacidification, activated carbon injection for dioxin removal, baghouse dedusting, residual heat recovery, etc. Although the processes can meet use requirements to some extent, there are still deficiencies as follows.

Firstly, direct denitration of flue gases at high temperatures followed by desulfurization results in low denitration efficiency.

Secondly, an extended process flow increases system complexity, capital investment and occupied area.

Thirdly, process conditions, such as temperature and flue gas residence time, cannot be precisely controlled, failing to achieve expected effect of pollutant removal.

Fourthly, a large amount of reductants, such as ammonia or urea, and limestones are consumed, leading to ammonia escape, secondary pollution discharge of desulfurized wastewater and other problems.

### SUMMARY

In order to solve the above problems, the present disclosure provides a purification apparatus for solid waste incineration flue gases, which integrates cooling and low-temperature adsorption functions, is capable of achieving unified removal of multiple pollutants, and offers advantages of high pollutant removal efficiency, comprehensive removal types, energy saving and environmental protection, low consumption, minimal secondary pollution, low capital investment and small occupied area.

In order to solve the above problems, the present disclosure provides technical solutions as follows.

Provided is a purification apparatus for solid waste incineration flue gases, characterized by including a heat exchanger, a quenching tower, a dust collector, a cooler, a gas-liquid separator and an adsorption device which communicate in sequence through pipelines. High-temperature solid waste incineration flue gases undergo cooling by the heat exchanger, rapid quenching by the quenching tower, dust removal by filtration by the dust collector, cooling by the cooler and gas-liquid separation by the gas-liquid separator, so as to yield low-temperature solid waste incineration flue gases and flue-gas cooling water. The low-temperature solid waste incineration flue gases enter the adsorption device to undergo adsorption purification before discharge.

As an implementable mode thereof, the heat exchanger is provided with a tube side and a shell side, where the tube side of the heat exchanger is provided with a first flue-gas inlet and a first flue-gas outlet, and the shell side of the heat exchanger is provided with a first cooling-water inlet and a first cooling-water outlet; and the first flue-gas inlet communicates with a flue duct;

first solid waste incineration flue gases enter the tube side of the heat exchanger through the first flue-gas inlet via the flue duct, low-temperature cooling water enters the shell side of the heat exchanger through the first cooling-water inlet, the first solid waste incineration flue gases in the tube side of the heat exchanger and the low-temperature cooling water in the shell side of the heat exchanger perform countercurrent heat exchange, and the first solid waste incineration flue gases in the tube side of the heat exchanger, after the heat exchange, form second solid waste incineration flue gases that flow out of the first flue-gas outlet; the low-temperature cooling water in the shell side of the heat exchanger, after the heat exchange, forms high-temperature cooling water that flows out of the first cooling-water outlet, and then is cooled by the cooling tower to form low-temperature cooling water again, which enters the shell side of the heat exchanger through the first cooling-water inlet; and

the first solid waste incineration flue gases have a temperature of 800–1,100° C, and the second solid waste incineration flue gases have a temperature of 400–600° C.

As an implementable mode thereof, the heat exchanger is water-cooled tubular heat exchange equipment.

As an implementable mode thereof, the quenching tower is provided with a second flue-gas inlet and a second flue-gas outlet, and the first flue-gas outlet communicates with the second flue-gas inlet through a pipeline;

the quenching tower is provided with a spray nozzle in a top portion, and the spray nozzle is provided with a cold-water inlet and a cold-water outlet; cold water enters the spray nozzle through the cold-water inlet, the spray nozzle atomizes the cold water using compressed air so as to form atomized cold water that is uniformly sprayed into the quenching tower from the cold-water outlet; and the second solid waste incineration flue gases enter the quenching tower through the second flue-gas inlet;

the atomized cold water in the quenching tower and the second solid waste incineration flue gases perform rapid heat exchange through sufficient contact, where the atomized cold water forms gaseous water after the rapid heat exchange, and the second solid waste incineration flue gases form third solid waste incineration flue gases after the rapid heat exchange; and

the gaseous water and the third solid waste incineration flue gases, together as fourth solid waste incineration flue gases, flow out of the second flue-gas outlet, where a temperature of the third solid waste incineration flue gases is 150–200 °C, bypassing a dioxin generation temperature zone; and a duration of the rapid heat exchange is 0.5–1 s.

As an implementable mode thereof, the dust collector is provided with a third flue-gas inlet and a third flue-gas outlet, the second flue-gas outlet communicates with the third flue-gas inlet through a pipeline; the fourth solid waste incineration flue gases enter the dust collector through the third flue-gas inlet; and the dust collector performs dust removal by filtration on particulate matters entrained in the fourth solid waste incineration flue gases, so as to form fifth solid waste incineration flue gases that flow out of the third flue-gas outlet.

As an implementable mode thereof, the dust collector is a baghouse dust collector, including an equipment main body and a dust-removing filter bag installed in the equipment main body; and talc powder pre-coating is applied to the dust-removing filter bag before using the dust-removing filter bag or before using the same again after reverse air flow cleaning.

As an implementable mode thereof, the particle matters include dust, fly ash, adhesive dust and dioxin.

As an implementable mode thereof, the cooler is provided with a tube side and a shell side; the tube side of the cooler is provided with a fourth flue-gas inlet and a fourth flue-gas outlet, the shell side of the cooler is provided with a second cooling-water inlet and a second cooling-water outlet; and the third flue-gas outlet communicates with the fourth flue-gas inlet through a pipeline;

the fifth solid waste incineration flue gases enter the tube side of the cooler through the fourth flue-gas inlet, low-temperature cooling water enters the shell side of the cooler through the second cooling-water inlet, the fifth solid waste incineration flue gases in the tube side of the cooler and the low-temperature cooling water in the shell side of the cooler perform countercurrent heat exchange, the fifth solid waste incineration flue gases in the tube side of the cooler, after the heat exchange, form sixth solid waste incineration flue gases that flow out of the fourth flue-gas outlet; the low-temperature cooling water in the shell side of the cooler, after the heat exchange, forms high-temperature cooling water that flows out of the second cooling-water outlet, and then is refrigerated by a refrigerator to form low-temperature cooling water again, which enters the shell side of the cooler through the second cooling-water inlet, where a temperature of the sixth solid waste incineration flue gases is 0–5 °C.

As an implementable mode thereof, the gas-liquid separator is provided with a fifth flue-gas inlet, a fifth flue-gas outlet and a flue-gas cooling water discharge port; and the fourth flue-gas outlet communicates with the fifth flue-gas inlet through a pipeline;

the sixth solid waste incineration flue gases enter the gas-liquid separator through the fifth flue-gas inlet; and the gas-liquid separator performs gas-liquid separation on the sixth solid waste incineration flue gases, so as to yield seventh solid waste incineration flue gases and flue-gas cooling water; and

the seventh solid waste incineration flue gases flow out of the fifth flue-gas outlet; and the flue-gas cooling water is discharged from the flue-gas cooling water discharge port.

As an implementable mode thereof, the adsorption device includes a first adsorption tower, a second adsorption tower, a heating blower, an induced draft fan and a recycling reduction device;

the first adsorption tower is provided with a sixth flue-gas inlet, a sixth flue-gas outlet, a first regeneration-gas inlet and a first regeneration-gas outlet; the second adsorption tower is provided with a seventh flue-gas inlet, a seventh flue-gas outlet, a second regeneration-gas inlet and a second regeneration-gas outlet; the first adsorption tower and the second adsorption tower are both provided with an adsorbent therein; the induced draft fan is provided with an eighth flue-gas inlet and an eighth flue-gas outlet; and the heating blower is provided with an air inlet and an air outlet;

the fifth flue-gas outlet communicates with the sixth flue-gas inlet and the seventh flue-gas inlet through pipelines, respectively, the pipeline communicating the fifth flue-gas outlet with the sixth flue-gas inlet and the pipeline communicating the fifth flue-gas outlet with the seventh flue-gas inlet are both provided with a first flue-gas valve; and the seventh solid waste incineration flue gases, switched via the first flue-gas valves, enter the first adsorption tower or the second adsorption tower through the sixth flue-gas inlet or the seventh flue-gas inlet, and undergo alternating adsorption purification by the adsorbent in the first adsorption tower or the second adsorption tower, so as to remove acid gases, carbon monoxide and heavy metals in the solid waste incineration flue gases, and subsequently form eighth solid waste incineration flue gases;

the sixth flue-gas outlet and the seventh flue-gas outlet communicate with the eighth flue-gas inlet through pipelines, respectively; the pipeline communicating the sixth flue-gas outlet with the eighth flue-gas inlet and the pipeline communicating the seventh flue-gas outlet with the eighth flue-gas inlet are both provided with a second flue-gas valve; the eighth solid waste incineration flue gases, switched via the second flue-gas valves, flow out of the sixth flue-gas outlet or the seventh flue-gas outlet, then enter the induced draft fan through the eighth flue-gas inlet, and then are discharged through the eighth flue-gas outlet;

the air outlet communicates with the first regeneration-gas inlet and the second regeneration-gas inlet through pipelines, respectively, and the pipeline communicating the air outlet with the first regeneration-gas inlet and the pipeline communicating the air outlet with the second regeneration-gas inlet are both provided with an air valve;

upon adsorption saturation of the adsorbent in the first adsorption tower or the second adsorption tower, alternating heating regeneration is required, in which case, low-temperature air enters the heating blower through the air inlet, and the heating blower heats the low-temperature air to form high-temperature air; the high-temperature air flows out of the air outlet, and is switched via the air valve to enter the first adsorption tower or the second adsorption tower through the first regeneration-gas inlet or the second regeneration-gas inlet, so as to perform the alternating heating regeneration on the adsorbent in the first adsorption tower or the second adsorption tower; upon completion of the alternating heating regeneration on the adsorbent in the first adsorption tower or the second adsorption tower, low-temperature air enters the first adsorption tower or the second adsorption tower via the heating blower, to perform cold blowing on the adsorbent in the first adsorption tower or the second adsorption tower, so as to wait for next alternating adsorption purification; and

the first regeneration-gas outlet and the second regeneration-gas outlet communicate with the recycling reduction device through pipelines, respectively; the pipeline communicating the first regeneration-gas outlet with the recycling reduction device and the pipeline communicating the second regeneration-gas outlet with the recycling reduction device are both provided with a gas valve; following the alternating heating regeneration with the high-temperature air, pollutant gases are formed; the pollutant gases are switched via the gas valves to flow out of the first regeneration-gas outlet or the second regeneration-gas outlet into the recycling reduction device to undergo recycling reduction disposal.

As an implementable mode thereof, the adsorbent is a zeolite-based molecular sieve; and the acid gases include sulfur dioxide, oxynitride, hydrogen chloride and hydrogen fluoride.

The present disclosure has beneficial technical effects as follows.

The purification apparatus for solid waste incineration flue gases of the present disclosure integrates the cooling and low-temperature adsorption functions, is capable of achieving the unified removal of multiple pollutants, and offers the advantages of high pollutant removal efficiency, comprehensive removal types, energy saving and environmental protection, low consumption, minimal secondary pollution, low capital investment and small occupied area.

### BRIEF DESCRIPTION OF DRAWINGS

The sole figure is a structural schematic view of an embodiment of a purification apparatus for solid waste incineration flue gases of the present disclosure.

In the drawing, 1. heat exchanger; 2. quenching tower; 3. dust collector; 4. cooler; 5. gas-liquid separator; 6. first adsorption tower; 7. second adsorption tower; 8. induced draft fan; 9. heating blower; 101. first flue-gas inlet; 201. first cooling-water inlet; 202. first cooling-water outlet; 301. second cooling-water inlet; 302. second cooling-water outlet; 401. flue-gas cooling water discharge port; 501. air inlet; 504. recycling reduction device.

### DETAILED DESCRIPTION OF EMBODIMENTS

Unless otherwise defined, all technical and scientific terms used herein have the same meanings as those commonly understood by those skilled in the art to which the present disclosure belongs; and the terms used in the specification of the present disclosure are merely for the purpose of describing specific embodiments, but are not intended to limit the present disclosure.

The phrase “embodiment” referred to in the present disclosure means that specific features, structures or characteristics described in conjunction with the embodiment can be included in at least one embodiment of the present disclosure. This phrase appearing at various positions of the specification does not necessarily refer to the same embodiment, or an independent or alternative embodiment mutually exclusive of another embodiment. Those skilled in the art could understand, in explicit and implicit manners, that an embodiment described herein can be combined with other embodiments.

In the description of the present disclosure, unless otherwise expressly specified or limited, the terms such as “provide”, “install”, and “connect” should be understood in a broad sense, for example, a connection may be a fixed connection, a detachable connection, or an integrated connection; it may be a mechanical connection or an electrical connection; it may be direct joining or indirect joining through an intermediary. Specific meanings of the above terms could be understood by those ordinarily skilled in the art according to specific situations.

Orientation or positional relationships indicated by the terms such as “upper”, “lower”, “left”, “right”, “front”, “back”, “top”, “bottom”, “inner”, and “outer” are orientation or positional relationships shown based on the drawings, or orientation or positional relationships in which the inventive product is conventionally placed during use, merely for the purpose of facilitating the description and for simplifying the description, rather than indicating or implying that a specified device or element must be in a specific orientation, or be constructed and operated in a certain orientation, and thus should not be construed as limitation to the present disclosure.

The terms such as “first”, “second”, and “third” are used solely to distinguish between elements with similar properties, and do not indicate or imply relative importance or a specific sequential order.

The terms “comprise”, “contain” or any other variants thereof are intended to encompass non-exclusive inclusion, and further may include other elements that are not listed definitely in addition to those listed.

Technical solutions of the present disclosure will be described below clearly and completely in conjunction with drawing and embodiments.

With reference to the sole figure, the present embodiment provides a purification apparatus for solid waste incineration flue gases, including a heat exchanger 1, a quenching tower 2, a dust collector 3, a cooler 4, a gas-liquid separator 5 and an adsorption device which communicate in sequence through pipelines. High-temperature solid waste incineration flue gases undergo cooling by the heat exchanger 1, rapid quenching by the quenching tower 2, dust removal by filtration by the dust collector 3, cooling by the cooler 4 and gas-liquid separation by the gas-liquid separator 5, yielding low-temperature solid waste incineration flue gases and flue-gas cooling water. The low-temperature solid waste incineration flue gases enter the adsorption device to undergo adsorption purification before discharge.

In the present embodiment, as an implementable mode thereof, the heat exchanger 1 is provided with a tube side and a shell side. The tube side of the heat exchanger 1 is provided with a first flue-gas inlet 101 and a first flue-gas outlet. The shell side of the heat exchanger 1 is provided with a first cooling-water inlet 201 and a first cooling-water outlet 202. The first flue-gas inlet 101 communicates with a flue duct.

First solid waste incineration flue gases enter the tube side of the heat exchanger 1 through the first flue-gas inlet 101 via the flue duct. Low-temperature cooling water enters the shell side of the heat exchanger 1 through the first cooling-water inlet 201. The first solid waste incineration flue gases in the tube side of the heat exchanger 1 and the low-temperature cooling water in the shell side of the heat exchanger 1 perform countercurrent heat exchange. The first solid waste incineration flue gases in the tube side of the heat exchanger 1, after the heat exchange, form second solid waste incineration flue gases that flow out of the first flue-gas outlet. The low-temperature cooling water in the shell side of the heat exchanger 1, after the heat exchange, forms high-temperature cooling water that flows out of the first cooling-water outlet 202, and then is cooled by the cooling tower to form low-temperature cooling water again, which enters the shell side of the heat exchanger 1 through the first cooling-water inlet 201.

The first solid waste incineration flue gases have a temperature of 800–1,100° C, and the second solid waste incineration flue gases have a temperature of 400–600° C.

In the present embodiment, as an implementable mode thereof, the heat exchanger 1 is water-cooled tubular heat exchange equipment.

In the present embodiment, as an implementable mode thereof, the quenching tower 2 is provided with a second flue-gas inlet and a second flue-gas outlet, and the first flue-gas outlet communicates with the second flue-gas inlet through a pipeline.

The quenching tower 2 is provided with a spray nozzle in a top portion, and the spray nozzle is provided with a cold-water inlet and a cold-water outlet. Cold water enters the spray nozzle through the cold-water inlet, the spray nozzle atomizes the cold water using compressed air so as to form atomized cold water, and the atomized cold water is uniformly sprayed into the quenching tower 2 from the cold-water outlet. The second solid waste incineration flue gases enter the quenching tower 2 through the second flue-gas inlet.

The atomized cold water in the quenching tower 2 and the second solid waste incineration flue gases perform rapid heat exchange through sufficient contact, where the atomized cold water forms gaseous water after the rapid heat exchange, and the second solid waste incineration flue gases form third solid waste incineration flue gases after the rapid heat exchange.

The gaseous water and the third solid waste incineration flue gases, together as fourth solid waste incineration flue gases, flow out of the second flue-gas outlet, where a temperature of the third solid waste incineration flue gases is 150–200° C, bypassing a dioxin generation temperature zone; and a duration of the rapid heat exchange is 0.5–1 s.

In the present embodiment, as an implementable mode thereof, the dust collector 3 is provided with a third flue-gas inlet and a third flue-gas outlet, and the second flue-gas outlet communicates with the third flue-gas inlet through a pipeline; the fourth solid waste incineration flue gases enter the dust collector 3 through the third flue-gas inlet; and the dust collector 3 performs dust removal by filtration on particulate matters entrained in the fourth solid waste incineration flue gases, thereby forming fifth solid waste incineration flue gases that flow out of the third flue-gas outlet.

In the present embodiment, as an implementable mode thereof, the dust collector 3 is a baghouse dust collector, including an equipment main body and a dust-removing filter bag installed in the equipment main body.

In order to prevent adhesive dust in the fourth solid waste incineration flue gases from sticking and clogging the dust-removing filter bag, while considering adsorption purification of dioxin potentially present in the fourth solid waste incineration flue gases, talc powder pre-coating is applied to the dust-removing filter bag before using the dust-removing filter bag or before using the same again after reverse air flow cleaning.

In the present embodiment, as an implementable mode thereof, the particle matters include dust, fly ash, adhesive dust and dioxin.

Adsorption removal of flue gas pollutants under low-temperature conditions yields an optimal removal effect, and thus the fifth solid waste incineration flue gases flowing out of the dust collector 3 enter the cooler 4 to undergo further cooling.

In the present embodiment, as an implementable mode thereof, the cooler 4 is provided with a tube side and a shell side. The tube side of the cooler 4 is provided with a fourth flue-gas inlet and a fourth flue-gas outlet. The shell side of the cooler 4 is provided with a second cooling-water inlet 301 and a second cooling-water outlet 302. The third flue-gas outlet communicates with the fourth flue-gas inlet through a pipeline.

The fifth solid waste incineration flue gases enter the tube side of the cooler through the fourth flue-gas inlet. Low-temperature cooling water enters the shell side of the cooler 4 through the second cooling-water inlet 301. The fifth solid waste incineration flue gases in the tube side of the cooler 4 and the low-temperature cooling water in the shell side of the cooler 4 perform countercurrent heat exchange. The fifth solid waste incineration flue gases in the tube side of the cooler 4, after the heat exchange, form sixth solid waste incineration flue gases that flow out of the fourth flue-gas outlet. The low-temperature cooling water in the shell side of the cooler 4, after the heat exchange, forms high-temperature cooling water that flows out of the second cooling-water outlet 302, and then is refrigerated by a refrigerator to form low-temperature cooling water again, which enters the shell side of the cooler 4 through the second cooling-water inlet 301. A temperature of the sixth solid waste incineration flue gases is 0–5 °C.

In the present embodiment, as an implementable mode thereof, the gas-liquid separator 5 is provided with a fifth flue-gas inlet, a fifth flue-gas outlet and a flue-gas cooling water discharge port 401, and the fourth flue-gas outlet communicates with the fifth flue-gas inlet through a pipeline.

The sixth solid waste incineration flue gases enter the gas-liquid separator 5 through the fifth flue-gas inlet; the gas-liquid separator 5 performs gas-liquid separation on the sixth solid waste incineration flue gases, yielding seventh solid waste incineration flue gases and flue-gas cooling water.

The seventh solid waste incineration flue gases flow out of the fifth flue-gas outlet; and the flue-gas cooling water is discharged from the flue-gas cooling water discharge port 401.

In the present embodiment, as an implementable mode thereof, the adsorption device includes a first adsorption tower 6, a second adsorption tower 7, a heating blower 9, an induced draft fan 8 and a recycling reduction device 504.

The first adsorption tower 6 is provided with a sixth flue-gas inlet, a sixth flue-gas outlet, a first regeneration-gas inlet and a first regeneration-gas outlet. The second adsorption tower 7 is provided with a seventh flue-gas inlet, a seventh flue-gas outlet, a second regeneration-gas inlet and a second regeneration-gas outlet. Both the first adsorption tower 6 and the second adsorption tower 7 are provided with an adsorbent therein. The induced draft fan 8 is provided with an eighth flue-gas inlet and an eighth flue-gas outlet. The heating blower 9 is provided with an air inlet 501 and an air outlet.

The fifth flue-gas outlet communicates with the sixth flue-gas inlet and the seventh flue-gas inlet through pipelines, respectively. The pipeline communicating the fifth flue-gas outlet with the sixth flue-gas inlet and the pipeline communicating the fifth flue-gas outlet with the seventh flue-gas inlet are both provided with a first flue-gas valve. The seventh solid waste incineration flue gases, switched via the first flue-gas valves, enter the first adsorption tower 6 or the second adsorption tower 7 through the sixth flue-gas inlet or the seventh flue-gas inlet, and undergo alternating adsorption purification by the adsorbent in the first adsorption tower 6 or the second adsorption tower 7, so as to remove acid gases, such as sulfur dioxide, oxynitride, hydrogen chloride and hydrogen fluoride, along with carbon monoxide and heavy metals in the solid waste incineration flue gases, thus subsequently forming eighth solid waste incineration flue gases.

The sixth flue-gas outlet and the seventh flue-gas outlet communicate with the eighth flue-gas inlet through pipelines, respectively. The pipeline communicating the sixth flue-gas outlet with the eighth flue-gas inlet and the pipeline communicating the seventh flue-gas outlet with the eighth flue-gas inlet are both provided with a second flue-gas valve. The eighth solid waste incineration flue gases, switched via the second flue-gas valves, flow out of the sixth flue-gas outlet or the seventh flue-gas outlet, then enter the induced draft fan 8 through the eighth flue-gas inlet, and then are discharged through the eighth flue-gas outlet.

The air outlet communicates with the first regeneration-gas inlet and the second regeneration-gas inlet through pipelines, respectively, and the pipeline communicating the air outlet with the first regeneration-gas inlet and the pipeline communicating the air outlet with the second regeneration-gas inlet are both provided with an air valve.

Upon adsorption saturation of the adsorbent in the first adsorption tower 6 or the second adsorption tower 7, alternating heating regeneration is required, in which case, low-temperature air enters the heating blower 9 through the air inlet 501, and the heating blower 9 heats the low-temperature air to form high-temperature air; the high-temperature air flows out of the air outlet, and is switched via the air valve to enter the first adsorption tower 6 or the second adsorption tower 7 through the first regeneration-gas inlet or the second regeneration-gas inlet, so as to perform alternating heating regeneration on the adsorbent in the first adsorption tower 6 or the second adsorption tower 7. Upon completion of the alternating heating regeneration on the adsorbent in the first adsorption tower 6 or the second adsorption tower 7, low-temperature air enters the first adsorption tower 6 or the second adsorption tower 7 via the heating blower 9, to perform cold blowing on the adsorbent in the first adsorption tower 6 or the second adsorption tower 7, thereby waiting for next alternating adsorption purification.

The first regeneration-gas outlet and the second regeneration-gas outlet communicate with the recycling reduction device 504 through pipelines, respectively. The pipeline communicating the first regeneration-gas outlet with the recycling reduction device 504 and the pipeline communicating the second regeneration-gas outlet with the recycling reduction device 504 are both provided with a gas valve. Following the alternating heating regeneration with the high-temperature air, pollutant gases are formed. The pollutant gases are switched via the gas valves to flow out of the first regeneration-gas outlet or the second regeneration-gas outlet into the recycling reduction device 504 to undergo recycling reduction disposal.

In the present embodiment, as an implementable mode thereof, the adsorbent is a zeolite-based molecular sieve.

Only several embodiments of the present disclosure are illustrated in the above, descriptions of which are specific and detailed, but should not be construed as limitation to the scope of the present disclosure. It should be noted that those ordinarily skilled in the art still could make various modifications and improvements without departing from the concept of the present disclosure, all of which shall fall within the scope of protection of the present disclosure. Therefore, the scope of protection of the present patent for invention should be determined by the claims attached.

1. A purification apparatus for solid waste incineration flue gases, comprising a heat exchanger, a quenching tower, a dust collector, a cooler, a gas-liquid separator and an adsorption device which communicate in sequence through pipelines, wherein high-temperature solid waste incineration flue gases undergo cooling by the heat exchanger, rapid quenching by the quenching tower, dust removal by filtration by the dust collector, cooling by the cooler and gas-liquid separation by the gas-liquid separator, so as to yield low-temperature solid waste incineration flue gases and flue-gas cooling water; and the low-temperature solid waste incineration flue gases enter the adsorption device to undergo adsorption purification before discharge.

2. The purification apparatus for solid waste incineration flue gases according to claim 1, wherein the heat exchanger is provided with a tube side and a shell side, wherein the tube side of the heat exchanger is provided with a first flue-gas inlet and a first flue-gas outlet, and the shell side of the heat exchanger is provided with a first cooling-water inlet and a first cooling-water outlet; and the first flue-gas inlet communicates with a flue duct;
first solid waste incineration flue gases enter the tube side of the heat exchanger through the first flue-gas inlet via the flue duct, low-temperature cooling water enters the shell side of the heat exchanger through the first cooling-water inlet, the first solid waste incineration flue gases in the tube side of the heat exchanger and the low-temperature cooling water in the shell side of the heat exchanger perform countercurrent heat exchange, and the first solid waste incineration flue gases in the tube side of the heat exchanger, after the heat exchange, form second solid waste incineration flue gases that flow out of the first flue-gas outlet; the low-temperature cooling water in the shell side of the heat exchanger, after the heat exchange, forms high-temperature cooling water that flows out of the first cooling-water outlet, and then is cooled by the cooling tower to form low-temperature cooling water again entering the shell side of the heat exchanger through the first cooling-water inlet; and
the first solid waste incineration flue gases have a temperature of 800–1,100° C, and the second solid waste incineration flue gases have a temperature of 400–600° C.

3. The purification apparatus for solid waste incineration flue gases according to claim 2, wherein the quenching tower is provided with a second flue-gas inlet and a second flue-gas outlet, and the first flue-gas outlet communicates with the second flue-gas inlet through a pipeline;
the quenching tower is provided with a spray nozzle in a top portion, and the spray nozzle is provided with a cold-water inlet and a cold-water outlet; cold water enters the spray nozzle through the cold-water inlet, the spray nozzle atomizes the cold water using compressed air so as to form atomized cold water that is uniformly sprayed into the quenching tower from the cold-water outlet; and the second solid waste incineration flue gases enter the quenching tower through the second flue-gas inlet;
the atomized cold water in the quenching tower and the second solid waste incineration flue gases perform rapid heat exchange through sufficient contact, wherein the atomized cold water forms gaseous water after the rapid heat exchange, and the second solid waste incineration flue gases form third solid waste incineration flue gases after the rapid heat exchange; and
the gaseous water and the third solid waste incineration flue gases, together as fourth solid waste incineration flue gases, flow out of the second flue-gas outlet, wherein a temperature of the third solid waste incineration flue gases is 150–200° C, bypassing a dioxin generation temperature zone; and a duration of the rapid heat exchange is 0.5–1 s.

4. The purification apparatus for solid waste incineration flue gases according to claim 3, wherein the dust collector is provided with a third flue-gas inlet and a third flue-gas outlet, the second flue-gas outlet communicates with the third flue-gas inlet through a pipeline; the fourth solid waste incineration flue gases enter the dust collector through the third flue-gas inlet; and the dust collector performs dust removal by filtration on particulate matters entrained in the fourth solid waste incineration flue gases, so as to form fifth solid waste incineration flue gases that flow out of the third flue-gas outlet.

5. The purification apparatus for solid waste incineration flue gases according to claim 4, wherein the dust collector is a baghouse dust collector, comprising an equipment main body and a dust-removing filter bag installed in the equipment main body; and talc powder pre-coating is applied to the dust-removing filter bag before using the dust-removing filter bag or before using the same again after reverse air flow cleaning, wherein the particle matters comprise dust, fly ash, adhesive dust and dioxin.

6. The purification apparatus for solid waste incineration flue gases according to claim 4, wherein the cooler is provided with a tube side and a shell side; the tube side of the cooler is provided with a fourth flue-gas inlet and a fourth flue-gas outlet, the shell side of the cooler is provided with a second cooling-water inlet and a second cooling-water outlet; and the third flue-gas outlet communicates with the fourth flue-gas inlet through a pipeline; and
the fifth solid waste incineration flue gases enter the tube side of the cooler through the fourth flue-gas inlet, low-temperature cooling water enters the shell side of the cooler through the second cooling-water inlet, the fifth solid waste incineration flue gases in the tube side of the cooler and the low-temperature cooling water in the shell side of the cooler perform countercurrent heat exchange, the fifth solid waste incineration flue gases in the tube side of the cooler, after the heat exchange, form sixth solid waste incineration flue gases that flow out of the fourth flue-gas outlet; the low-temperature cooling water in the shell side of the cooler, after the heat exchange, forms high-temperature cooling water that flows out of the second cooling-water outlet, and then is refrigerated by a refrigerator to form low-temperature cooling water again entering the shell side of the cooler through the second cooling-water inlet, wherein a temperature of the sixth solid waste incineration flue gases is 0–5 °C.

7. The purification apparatus for solid waste incineration flue gases according to claim 6, wherein the gas-liquid separator is provided with a fifth flue-gas inlet, a fifth flue-gas outlet and a flue-gas cooling water discharge port; and the fourth flue-gas outlet communicates with the fifth flue-gas inlet through a pipeline;
the sixth solid waste incineration flue gases enter the gas-liquid separator through the fifth flue-gas inlet; and the gas-liquid separator performs gas-liquid separation on the sixth solid waste incineration flue gases, so as to yield seventh solid waste incineration flue gases and flue-gas cooling water; and
the seventh solid waste incineration flue gases flow out of the fifth flue-gas outlet; and the flue-gas cooling water is discharged from the flue-gas cooling water discharge port.

8. The purification apparatus for solid waste incineration flue gases according to claim 7, wherein the adsorption device comprises a first adsorption tower, a second adsorption tower, a heating blower, an induced draft fan and a recycling reduction device;
the first adsorption tower is provided with a sixth flue-gas inlet, a sixth flue-gas outlet, a first regeneration-gas inlet and a first regeneration-gas outlet; the second adsorption tower is provided with a seventh flue-gas inlet, a seventh flue-gas outlet, a second regeneration-gas inlet and a second regeneration-gas outlet; the first adsorption tower and the second adsorption tower are both provided with an adsorbent therein; the induced draft fan is provided with an eighth flue-gas inlet and an eighth flue-gas outlet; and the heating blower is provided with an air inlet and an air outlet;
the fifth flue-gas outlet communicates with the sixth flue-gas inlet and the seventh flue-gas inlet through pipelines, respectively, the pipeline communicating the fifth flue-gas outlet with the sixth flue-gas inlet and the pipeline communicating the fifth flue-gas outlet with the seventh flue-gas inlet are both provided with a first flue-gas valve; and the seventh solid waste incineration flue gases, switched via the first flue-gas valves, enter the first adsorption tower or the second adsorption tower through the sixth flue-gas inlet or the seventh flue-gas inlet, and undergo alternating adsorption purification by the adsorbent in the first adsorption tower or the second adsorption tower, so as to remove acid gases, carbon monoxide and heavy metals in the solid waste incineration flue gases, and subsequently form eighth solid waste incineration flue gases;
the sixth flue-gas outlet and the seventh flue-gas outlet communicate with the eighth flue-gas inlet through pipelines, respectively; the pipeline communicating the sixth flue-gas outlet with the eighth flue-gas inlet and the pipeline communicating the seventh flue-gas outlet with the eighth flue-gas inlet are both provided with a second flue-gas valve; the eighth solid waste incineration flue gases, switched via the second flue-gas valves, flow out of the sixth flue-gas outlet or the seventh flue-gas outlet, then enter the induced draft fan through the eighth flue-gas inlet, and then are discharged through the eighth flue-gas outlet;
the air outlet communicates with the first regeneration-gas inlet and the second regeneration-gas inlet through pipelines, respectively, and the pipeline communicating the air outlet with the first regeneration-gas inlet and the pipeline communicating the air outlet with the second regeneration-gas inlet are both provided with an air valve;
upon adsorption saturation of the adsorbent in the first adsorption tower or the second adsorption tower, alternating heating regeneration is required, in which case, low-temperature air enters the heating blower through the air inlet, and the heating blower heats the low-temperature air to form high-temperature air; the high-temperature air flows out of the air outlet, and is switched via the air valve to enter the first adsorption tower or the second adsorption tower through the first regeneration-gas inlet or the second regeneration-gas inlet, so as to perform the alternating heating regeneration on the adsorbent in the first adsorption tower or the second adsorption tower; upon completion of the alternating heating regeneration on the adsorbent in the first adsorption tower or the second adsorption tower, low-temperature air enters the first adsorption tower or the second adsorption tower via the heating blower, to perform cold blowing on the adsorbent in the first adsorption tower or the second adsorption tower, so as to wait for next alternating adsorption purification; and
the first regeneration-gas outlet and the second regeneration-gas outlet communicate with the recycling reduction device through pipelines, respectively; the pipeline communicating the first regeneration-gas outlet with the recycling reduction device and the pipeline communicating the second regeneration-gas outlet with the recycling reduction device are both provided with a gas valve; following the alternating heating regeneration with the high-temperature air, pollutant gases are formed; the pollutant gases are switched via the gas valves to flow out of the first regeneration-gas outlet or the second regeneration-gas outlet into the recycling reduction device to undergo recycling reduction disposal.

9. The purification apparatus for solid waste incineration flue gases according to claim 8, wherein the adsorbent is a zeolite-based molecular sieve; and the acid gases comprise sulfur dioxide, oxynitride, hydrogen chloride and hydrogen fluoride.

10. The purification apparatus for solid waste incineration flue gases according to claim 1, wherein the heat exchanger is water-cooled tubular heat exchange equipment.
